(19) United States
(12) Patent Application Publication
(10) Pub. No.: US 2022/0240663 A1
(43) Pub. Date: Aug. 4, 2022

(54) Method for Manufacturing a Brush

(71) Applicant: M+C Schiffer GmbH, Neustadt/Wied (DE)

(72) Inventor: Thomas Clos, Koeln (DE)

(21) Appl. No.: 17/592,321

(22) Filed: Feb. 3, 2022

(30) Foreign Application Priority Data
Feb. 4, 2021 (DE) 10 2021 102 624.5

(51) Int. Cl. A46D 3/04; A46D 1/00; A46D 1/04; A46B 9/04

(52) U.S. Cl. CPC A46D 3/045; A46D 1/0207; A46B 2200/1066; A46B 9/04; A46D 1/04

(57) ABSTRACT

A method for manufacturing a toothbrush having a bristle carrier made of a thermoplastic material with a front side and a rear side is provided. At least one recess formed as a blind hole in the bristle carrier extends from the front side in the bristle carrier, and holds at least one bristle. The at least one bristle is received in a receiving opening of a tool melted to form a thickening at its attachment-side end and inserted with its attachment-side end into the recess. The thermoplastic material is heated and, by pressing the tool against the front side of the bristle carrier, is deformed such that the thermoplastic material is displaced radially inwards into the recess, at least in the region of an edge surrounding the recess, for the form-fitting sealing of the thickening, in that a projection provided radially adjacent to the recess is pressed into the thermoplastic material.

### CROSS-REFERENCE TO RELATED APPLICATION

This application claims priority to German Patent Application No. 10 2021 102 624.5 filed Feb. 4, 2021, the disclosure of which is hereby incorporated by reference in its entirety.

### BACKGROUND OF THE INVENTION

### Field of the Invention

The present invention relates to a method for manufacturing a brush, in particular a toothbrush, which has a bristle carrier made of a thermoplastic material with a front side and a rear side, wherein at least one recess formed as a blind hole in the bristle carrier extends from the front side, in which recess at least one bristle is held.

### Description of Related Art

Such brushes are generally known. In particular, the present invention aims to improve the way in which the bristle can be attached to the bristle carrier.

EP 1 110 479 A1 relates to a method of attaching bristle bundles for brushes to carriers made of plastic, in which a recess recessed in the bristle carrier is configured as a through-hole.

WO 2017/186371 A1 describes a generic method in which the bristle is received in a receiving opening of a tool formed as a blind hole and is melted on at its attachment-side end. The bristle is then inserted into the blind hole with its attachment-side end. The distance between the tool and the bristle carrier is reduced so that the tool contacts the bristle carrier. In the approach according to WO 2017/186371 A1, the tool is heated so that when the tool is applied against the front side, the thermoplastic material is softened. The tool has a tool surface the contour of which corresponds to the front side.

Thus, the approach according to this prior art is to soften the thermoplastic material locally in the area of the surface and to push the material of the bristle carrier radially into the recess by an external pressure by pressing the tool against the front side, so that the thickening is covered by the thermoplastic material at least in the area of the front side and is thus held in the recess in a form-fitting manner. This is because after the material of the bristle carrier has been deformed, the tool is removed from the bristle carrier and the bristle is pulled out of the receiving opening.

Thus, the proposal according to WO 2017/186371 A1 counters a disadvantage according to DE 198 53 030 A1, in which the brush body is compressed as a whole after insertion of the bristle bundle in order to enclose the thickening within the bristle carrier.

However, it has been shown that both proposals require comparatively high pressures in order to plastically deform the thermoplastic material of the bristle carrier such that the bristle is securely connected to the bristle carrier. Incidentally, the pressing force acting longitudinally through the brush body also leads to a tendency of the brush head to be deformed outwardly. In view of this, WO 2017/186371 A1 proposes a die that completely encloses the bristle carrier, at least in the region of the brush head of the bristle carrier that holds the bristle, which is intended to prevent undesirable deformation of the bristle carrier. However, the solution is structurally complex.

### SUMMARY OF THE INVENTION

The present invention aims to simplify the method previously described.

In view of the above, the present invention proposes a method with the features as described herein.

In this method, the thermoplastic material is heated in the same way as in the method according to WO 2017/186371 A1, so that the thermoplastic material flows as a result of compressive stress and can thus seal the bundle with its thickening in the bristle carrier in a form-fitting manner. However, this deformation of the thermoplastic material is effected by a projection which is pressed into the thermoplastic material adjacent to the recess, i.e. radially thereto. The corresponding projection causes a local deformation of the heated thermoplastic material, which seals the thickening into the bristle carrier as a result of this deformation. The projection thereby acts against the usually flat, smooth and shoulder-free front surface on the front side of the bristle carrier.

With the present invention, it is proposed on the one hand to heat the thermoplastic material so that it can be deformed more easily, but on the other hand to limit this deformation only to an area immediately around the recess on the front surface of the bristle carrier. This reduces the overall forces required for form-fit sealing of the thickening. The method can thus be carried out more easily and thus more cost-effectively.

The method according to the invention is usually carried out to connect a plurality of bristles, usually each comprising a plurality of filaments, to the bristle carrier so that the bristles are held as a bristle bundle on the bristle carrier. For this purpose, the tool has a plurality of receiving openings. The receiving openings are usually formed as continuous channels. This allows the bristle or bristle bundle to be displaced axially relative to the tool, for example to displace individual filaments within a bristle bundle, in order to thus contour the bristle bundle on the use side before the thickening is formed on the fastening side by melting. During insertion into the recess, the bristle bundle is either clamped circumferentially, for example on the tool, but preferably supported on the use side, i.e. at its free end face.

In the preferred method of processing, several bristles are inserted into the recess assigned to them as the tool moves towards the bristle carrier. It is understood that the bristles or bristle bundles held on the tool have previously been provided with an independent thickening per bristle or bristle bundle by melting. In this preferred method of processing, at least one projection is pressed into the thermoplastic material for each of the recesses in order to seal the thickening in the corresponding recess in a form-fitting manner.

Thereafter, a brush with a plurality of bristles, in particular bristle bundles, can be economically and easily manufactured.

In the solution according to the invention the recess can be formed as a blind hole in the bristle carrier. With regard to the basic shape of the recess, the solution according to the invention is not subject to any particular restrictions. For example, the recess can be a circular opening. However, the recess can also have an elongated opening in the front surface of the bristle carrier which runs in a straight line or is curved.

The movement of the tool can be displacement- or force-controlled. The force to be applied is determined as the force necessary to achieve the desired deformation of the thermoplastic material, which is locally limited to the respective recess, so that the thickening is sealed in the bristle carrier in a form-fitting manner.

According to a preferred further development of the present invention, a tool surface provided opposite the front side of the bristle carrier and corresponding to the contour of the front side of the bristle carrier is approached together with the projection in the direction of the bristle carrier. At the end of the relative movement between the bristle carrier and the tool, the corresponding tool surface is placed in a planar manner against the front side of the bristle carrier. Thus, the infeed movement of the tool finds a predeterminable end point through planar contact against the bristle carrier. The infeed movement of the tool can be force-controlled. With the tool applied against the bristle carrier, the force required to move the tool increases sharply. This increase in force can be evaluated as a signal to end the infeed movement and to qualify the sealing of the thickening as completed.

The tool is then lifted, causing the bristle or all the bristles held in it to pull out of the tool as they are connected to the bristle carrier.

In accordance with a preferred further development of the present invention, the projection acts on the front side of the brush body in the form of ring segments lying on a ring surface. The ring segments may be provided in immediate succession and form a closed ring. Alternatively, the ring segments may be provided at a distance from each other and leave spaces between them formed by the planar and smooth surface of the tool.

This ring or the ring segments spaced apart from one another on the ring surface surrounds/encircles the respective recess completely or circumferentially. The ring does not necessarily have to be a ring with a circular shape. Rather, the ring is adapted to the outer contour of the recess and usually surrounds it circumferentially at a constant distance from the edge of the recess. Ring segments surrounding several recesses may intersect, so that adjacent recesses share a projection at least at one point.

The distance should be less than 1 millimeter. The distance is understood to be the minimum distance of the thickening from the edge of the recess. In the case of a tapered projection, the distance should be maintained even when the projection is pressed into the thermoplastic material to the maximum extent. The distance between the projection and the edge is preferably between 0.5 mm and 0.05 mm.

With respect to good deformation, the projection is preferably configured with a tapered cross-sectional geometry. In this configuration, the tip of the projection initially strikes the upper side of the bristle carrier when the projection approaches the bristle carrier. In this case, the projection has a deformation surface that is inclined in the direction of the recess. The opposite surface facing away from the recess can be of any configuration. For example, it can extend orthogonally to the front surface of the bristle carrier. The tapered, wedge-shaped cross-sectional geometry results in an increase in the force required to move the tool as it approaches. The actual force applied can be used to control the press-in depth.

Alternatively, the projection can also be cylindrical in cross-section with a dome-shaped front end. The front end of the projection acting on the thermoplastic material is preferably semicircular in cross-sectional view.

Preferably, the protrusion is heated to soften the thermoplastic material. The temperature of the projection can correspond to the temperature of the tool. However, in order to achieve the most energy-efficient method of processing, it is suggested that the projection protruding from the tool surface be assigned a heater that heats the projection to a higher temperature than the tool surface. Thus, the area of the projection that protrudes from the tool surface is preferably underlaid with a heater. This ensures that the projection is heated more than the tool surface. By appropriately selecting materials with different thermal conductivities, the heat extraction can be aligned with the projection. The material forming the projection should have a higher thermal conductivity than the material of the tool.

According to a preferred further development of the present invention, the bristle carrier still has an elevated temperature due to injection molding when the thickening is sealed in a form-fitting manner. This temperature is usually at least 20, preferably at least 30 degrees above room temperature. As a result, the method according to the invention can be carried out in a particularly energy-saving manner. After injection molding, the bristle carrier is not first cooled and then heated at least locally in the region of the front side. Instead, the heating of the bristle carrier due to injection molding is used to achieve improved plastic deformation when the projection penetrates the thermoplastic material.

For this purpose, it can be useful to remove the bristle carrier from the injection mold with a mold cavity segment, which usually forms at least the rear side of the bristle carrier during injection of the molten plastic. Such a mold cavity segment is usually inserted into the actual injection mold. The mold cavity segment is usually provided with cooling channels on the injection mold side, so that the bristle carrier is cooled and brought below the solidification temperature for at least as long as this takes place during normal injection molding up to demolding. For ease of handling, the mold cavity segment itself is not provided with cooling channels. In the preferred further embodiment of the present invention discussed here, surprisingly, when the injection mold is opened, the bristle carrier is left in the mold cavity segment opposing a mold cavity having pins that form the at least one recess in the bristle body during injection molding. For this purpose, the injection mold may have holding-down devices or the like which act on the injection-molded bristle carrier to leave it in the mold cavity segment molding the rear side of the bristle carrier, while the opposite mold half lifts off the bristle carrier and thereby pulls the at least one pin out of the recess in the bristle carrier.

The further developments described herein may in themselves be essential to the invention, i.e. define the invention together with the features described herein.

### BRIEF DESCRIPTION OF THE DRAWINGS

Further details and advantages of the present invention will be apparent from the following description of an embodiment in conjunction with the drawing. Therein:

FIG. 1 shows schematic views of various stations of the method of processing, wherein in each station A-F perspective views of the respective components are shown from above and from below;

FIG. 2 shows a cross-sectional view of the bristle carrier and the tool prior to insertion of the thickening into a recess; and

FIG. 3 shows a cross-sectional view according to FIG. 2 after the thickening has been inserted into the recess;

FIG. 4 shows a cross-sectional view according to FIGS. 2 and 3 during sealing of the thickening in the recess, and

FIG. 5 shows a cross-sectional view according to FIG. 4 for an alternative form of projection.

### DESCRIPTION OF THE INVENTION

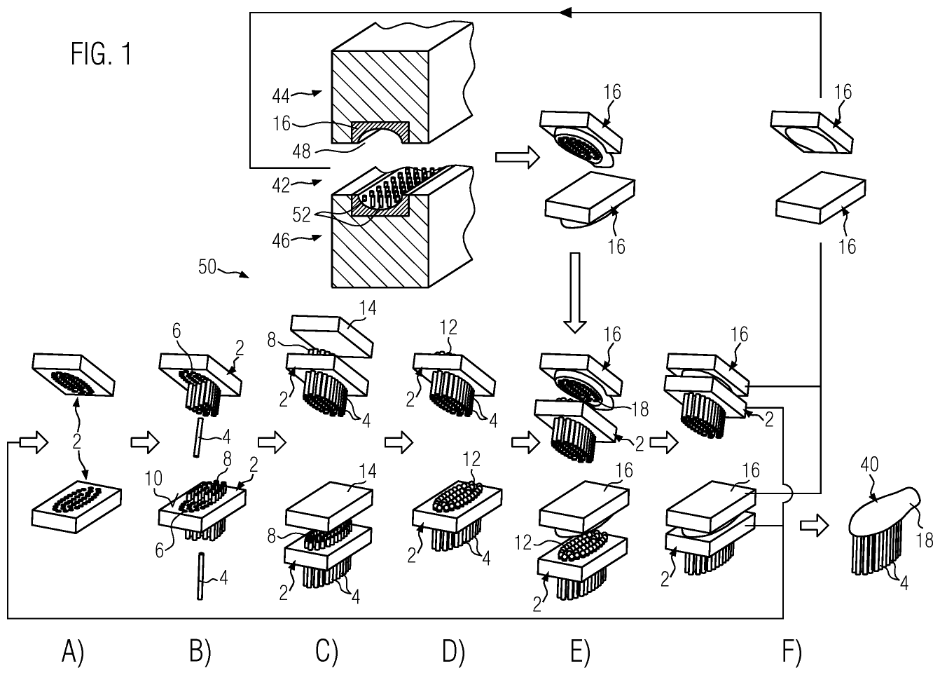

In FIG. 1, A characterizes a placement station in which a tool 2 with a plurality of bristles 4 formed as a bristle bundle is filled with a plurality of filaments. For this purpose, the tool 2 has a plurality of receiving openings 6 in the form of holding channels. The respective bristles 4 project with their attachment-side end 8 over a tool surface 10.

In the heating station shown in FIG. 1B, the attachment-side end 8 of the bristles 4 is melted to form a thickening 12, for which purpose a heat source 14 is arranged opposite the tool 2. The heat from the heat source 14 melts all the filaments of a bristle 4 at the same time and forms them into a unit via the thickening 12. As usual, the thickening 12 projects radially beyond the bristle 4 after melting. Thus, the attachment-side end 8 of the bristle 4 is thicker than the diameter of the bristle 4 itself.

In station 10, the thickening 12 cools down.

In station 1D, a carrier plate 16 is arranged opposite the tool 2 and holds a bristle carrier 18. In the embodiment shown, the bristle carrier 18 comprises the head of a toothbrush with a plurality of recesses 20.

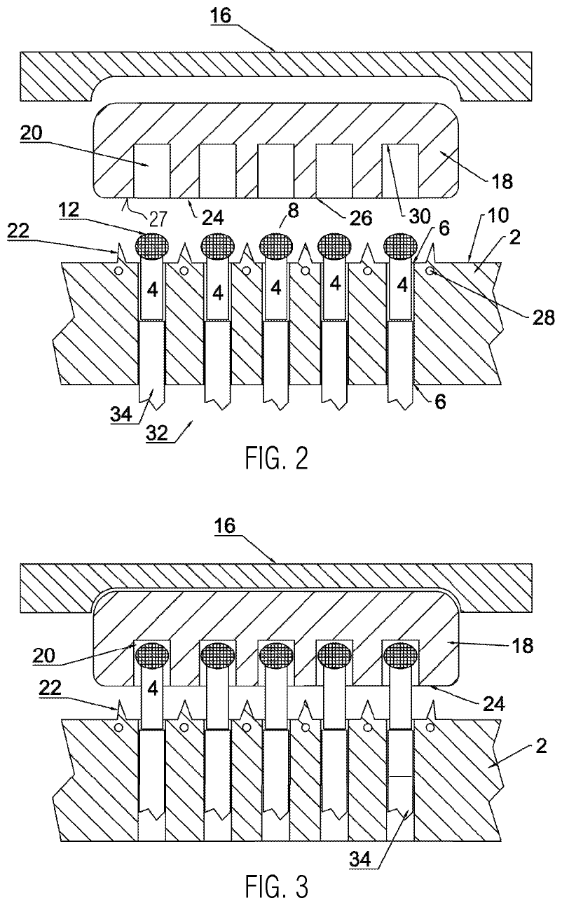

In FIG. 1E, the bristle carrier 18 and thus the carrier plate 16 and the tool 2 have been moved towards each other. In the course of this relative movement, the attachment-side end 8 with the thickening 12 is inserted into one of the recesses 20, which is shown in detail in FIGS. 2 to 4.

The sectional views according to FIGS. 2 to 4 show the oblong hole forming the receiving opening 6 in cross-sectional view. The bristle 4 is received therein. The thickening 12 projects beyond the tool surface 10. Furthermore, a projection 22 projects from the tool surface 10, which in the present case is configured to taper toward its free end. The projection 22 is configured as a self-contained ring and accordingly completely surrounds the bristle 4. The projection 22 projects from the otherwise planar tool surface 10. This tool surface 10 is otherwise just like a front surface of the bristle carrier 18 characterized by reference sign 24. This front surface 24 and the tool surface 10 have the same course. They are identically shaped.

The recess 22 forms a right-angled rim with the front surface 24, the boundary surface of which, lying in a front side 25, is characterized as an edge with reference sign 27.

The sectional view shown in FIGS. 2 to 4 also illustrates a heating assembly 28 underlying the projection 22 so that the projection 22 is heated to an elevated temperature.

Starting from the initial position shown in FIG. 2, the bristles 4 are brought closer to the tool 2. In this process, the thickening 12 is inserted into the recess 20 (FIG. 3). In the embodiment shown, this insertion movement is performed by moving a feed device 32, which comprises a plurality of feed pins 34 configured with the pattern of receiving openings 6 in the tool 2 and abutting against use-side ends 36 of all bristles 4, relative to the tool 2. As a result, the bristles 4 are moved toward and out of the tool 2 relative to each other. Initially, the distance of the tool 2 relative to the carrier plate 16 is not changed.

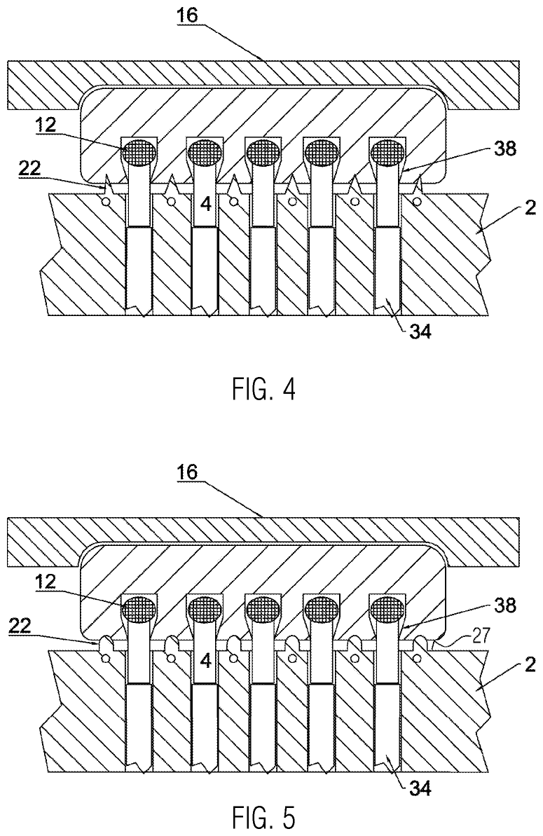

The thickening 12 finally abuts against a bottom of the recess 20, which is characterized by reference sign 30. Thereafter, the tool 2 is approached in the direction of the bristle carrier 18. The bristles and the feed device 32 remain stationary relative to the bristle carrier 18. As a result of this approach, the projection 22 contacts the front surface 24 of the bristle carrier 18 with its tapering end. As the distance between the tool 2 and the bristle carrier 18 is progressively reduced, the projection 22 is forced into the edge 27. In this process, the thermoplastic material softened by heating is displaced radially inwards into the recess 20. As a result, the thermoplastic material flows and deforms plastically. It approaches the outer circumference of the bristle 4, and if necessary the thermoplastic material also abuts against the outer circumference of the bristle 4. At the end of the deformation of the edge 27, the thermoplastic material covers the thickening 12 at reference sign 38. As a result, the thickening 12 is positively sealed in the bristle carrier 18 (cf. FIG. 4).

Subsequently, the distance between the tool 2 and the bristle carrier 18 is increased. The bristle 4 remains stationary due to the form-fit retention of the thickening 12 in the bristle carrier 18. The tool 2 is removed, leaving the bristle 4 in the bristle carrier 18.

In FIG. 1, the feed device 32 is omitted in favor of a clear graphical representation. After removal of the tool 18, a brush is obtained, characterized by reference sign 40, which consists of the injection-molded bristle carrier 18 and the bristles 4.

It is understood that the bristle carrier 18 can be manufactured during preparation by injection molding as a multi-component injection molded part with different material components including at least one elastomeric component. In FIG. 1, reference sign 42 characterizes an injection mold formed by two mold halves 44, 46. The upper mold half, characterized by reference sign 44, has a carrier plate receptacle 48 in which the carrier plate 16, reproduced in position A1 for itself with the bristle carrier 18, is received. As shown schematically in FIG. 1, the carrier plate 16 is returned from position E to the injection mold 42. Thus, the carrier plate 16 is removed from a sealing section characterized by reference sign 50 and reused for molding the bristle carrier 18. In the area of the injection mold 42, reference signs 52 characterize pins provided on the lower mold half 46 in the cavity forming the bristle carrier 18.

FIG. 1 also shows that the tool 2 remains on the sealing section and, after removal of the bristles 4 (see position F), is returned to position A and provided with bristles 4.

By removing the bristle carrier 18 from the injection mold 42, the bristle carrier 18 can still be handled at a relatively high temperature. Thus, the approach of the mold 2 to seal in the bristles 4 occurs at a temperature at which the material of the bristle carrier 18 is still heated by the injection molding cycle. Thus, the energy expended for the injection molding process is used to keep the thermoplastic material of the bristle carrier 18 as soft and flowable as possible with respect to the sealing-in of the bristles 4. Accordingly, the method according to the invention can be carried out in a particularly resource-saving manner.

FIG. 6 shows an alternative cross-sectional configuration of the projection 22, which results in a different deformation behavior of the thermoplastic material when the tool 2 and the bristle carrier 18 approach each other. Here, the projection 22 has a cylindrical base which is provided with a dome, i.e. covered by a semicircular cap.

### LIST OF REFERENCE SIGNS

2 tool
4 bristle
6 receiving opening
8 attachment-side end
10 tool surface
12 thickening
14 heat source
16 carrier plate
18 bristle carrier
20 recess
22 projection
24 front surface
25 front side
26 rim
27 edge
28 heating assembly
30 bottom
32 feed device
34 feed pin
36 use-side end
38 cover
40 brush
42 injection mold
44 upper mold half
46 lower mold half
48 carrier plate receptacle
50 sealing section
52 pin

1. A method for manufacturing a toothbrush, which has a bristle carrier made of a thermoplastic material with a front side and a rear side, wherein at least one recess formed as a blind hole in the bristle carrier extends from the front side in the bristle carrier, in which recess at least one bristle is held, in which
the at least one bristle is received in a receiving opening of a tool,
the at least one bristle is melted to form a thickening at its attachment-side end;
the at least one bristle is inserted with its attachment-side end into the recess;
the distance between the tool and the bristle carrier is reduced so that the tool contacts the bristle carrier,
the thermoplastic material is heated and, by pressing the tool against the front side of the bristle carrier, is deformed such that the thermoplastic material is displaced radially inwards into the recess, at least in the region of an edge surrounding the recess, for the form-fitting sealing of the thickening, in that a projection provided radially adjacent to the recess is pressed into the thermoplastic material, the method comprising:
applying a tool surface provided opposite the front side of the bristle carrier and corresponding to the contour of the front side of the bristle carrier to the projection in the direction of the bristle carrier in a planar manner against the front side at the end of the relative movement between the bristle carrier and the tool.

2. The method according to claim 1, wherein the projection acts on the front of the brush body in the form of ring segments lying on a ring surface.

3. The method according to claim 1, wherein the projection has a cross-sectional geometry tapering at one end.

4. The method according to claim 1, wherein the projection has a V-shaped cross-sectional geometry.

5. The method according to claim 1, wherein the projection has a dome-shaped cross-sectional geometry.

6. The method according to claim 1, further comprising heating the projection.

7. The method according to claim 1, further comprising heating the projection to a higher temperature than the tool surface, wherein the projection protrudes from the tool surface and the projection is assigned a heater provided on the tool by means of which the projection is heated.

8. The method according to claim 1, wherein the bristle carrier has a plurality of recesses and the tool has a plurality of receiving openings, in each of which a bristle bundle having a plurality of bristles is provided, further comprising:
melting the bristle bundles to form a thickening;
inserting the attachment-side end into the assigned recess, and
displacing the edge surrounding the respective recess radially inwards into the recess for form-fitting sealing of the respective thickening, in that a projection provided radially adjacent to the respective recess is pressed into the thermoplastic material.

9. The method according to claim 1, wherein the bristle carrier still has an increased temperature due to the injection molding when the thickening is sealed in a form-fitting manner.

10. The method according to claim 1, further comprising holding the bristle carrier in a mold cavity segment at least partially molding the bristle carrier during form-fitting sealing of the thickening.

11. The method according to claim 9, further comprising removing the mold cavity segment together with the bristle carrier from an injection mold forming the bristle carrier before the form-fitting sealing of the thickening and is moved on a sealing section on which the thickening is sealed in and the bristle carrier is then removed from the mold cavity segment and the mold cavity segment is removed from the sealing section and inserted into the injection mold.
